(19) United States
(12) Patent Application Publication
(10) Pub. No.: US 2012/0002924 A1
(43) Pub. Date: Jan. 5, 2012

(54) STAR COUPLER AND OPTICAL MULTIPLEXER/DEMULTIPLEXER

(75) Inventor: Hideaki OKAYAMA, Tokyo (JP)

(73) Assignee: OKI ELECTRIC INDUSTRY CO., LTD., Tokyo (JP)

(21) Appl. No.: 13/159,984

(22) Filed: Jun. 14, 2011

(30) Foreign Application Priority Data
Jul. 2, 2010 (JP) 2010-151619

(51) Int. Cl. G02B 6/26

(52) U.S. Cl. 385/46

(57) ABSTRACT

A star coupler includes a core embedded in a clad on a major surface of a substrate. The refractive index of the core differs by at least 40% from the refractive index of the clad. The core includes a slab optical waveguide, at least one input-output optical waveguide connected to the slab optical waveguide, and an array of channel optical waveguides connected to the slab optical waveguide. The star coupler also includes a high-index layer having a refractive index intermediate between the refractive indexes of the clad and core, covering the sides of the core orthogonal to the major surface of the substrate. The high-index layer reduces light loss.

### BACKGROUND OF THE INVENTION

1. Field of the Invention

The present invention relates to a star coupler and to an optical multiplexer/demultiplexer of the arrayed waveguide grating type including the star coupler.

2. Description of the Related Art

The use of silicon (Si) as an optical waveguide material is a technology that has gained attention as a way of mass-producing optical elements and reducing their size. One known type of silicon optical element is an optical multiplexer/demultiplexer. This type of element is used in optical subscriber telecommunication systems to multiplex light of different wavelengths into a single optical fiber and to separate the different wavelengths of light exiting the fiber.

Among the various optical multiplexer/demultiplexer structures, recently there has been much interest in optical multiplexer/demultiplexers employing an arrayed waveguide grating (AWG) structure, which combines good multiplexing and demultiplexing characteristics with small size.

In ‘Center wavelength uniformity of shallow-etched silicon photonic wire AWG’, Group IV Photonics 2009 IEEE paper ThP6, Sep. 10, 2009, Kim et al. describe an arrayed waveguide grating that uses silicon as a waveguide material to achieve very small waveguide dimensions. At the interfaces between the arrayed waveguides and the slab waveguides in the star couplers at the input and output ends of the AWG structure, the width of the waveguides in the array is equivalent to the widths of the spaces between the waveguides. An unwanted result is that much of the light propagating in the slab waveguides is lost to the outside by radiation through the spaces between the arrayed waveguides.

U.S. Pat. No. 6,973,236 (WO 2004/061498 A1) and Japanese Patent Application Publications No. 2006-30687, 2005-202373, 2004-325865, 2004-170627, 2004-29073, 2002-62444, 2001-159718, and 2000-147283 describe various attempts to deal with the corresponding problem in quartz waveguides, but none of the methods employed are readily applicable to an AWG with silicon waveguides.

### SUMMARY OF THE INVENTION

An object of the present invention is to reduce light loss in a silicon star coupler.

Another object is to reduce light loss in an AWG optical multiplexer/demultiplexer employing silicon star couplers.

Through diligent study, the inventors have found that these objects can be achieved by providing layers of a material with a high refractive index on the sides of the optical waveguides.

A star coupler according to the present invention includes a slab optical waveguide, at least one input-output optical waveguide connected to the slab optical waveguide, and a plurality of channel optical waveguides connected to and radiating out from the slab optical waveguide. These waveguides are embedded as a core in a clad disposed on a major surface of a substrate. The refractive index of the core differs by at least 40% from the refractive index of the clad. The star coupler also includes a high-index layer of a material having a refractive index intermediate between the refractive index of the clad and the refractive index of the core, covering the sides of the core orthogonal to the major surface of the substrate.

In some preferred embodiments of the invention, the top surface of the core, which is parallel to the major surface of the substrate, is also covered by the high-index layer.

In further preferred embodiments, the bottom surface of the core, which is parallel to the major surface of the substrate, is also covered by a high-index layer.

In still further preferred embodiments, the high-index layers on the sides of the core extend below the bottom surface of the core.

In other preferred embodiments, the refractive index nw of the core, the refractive index nc of the clad, and the refractive index nf of the high-index layer satisfy the condition

0.12×(nw−nc)>nf−nc

In yet other preferred embodiments, the high-index layer has a thickness greater than one-half the width of the spaces between mutually adjacent channel optical waveguides at the interface between the channel optical waveguides and the slab optical waveguide.

An optical multiplexer/demultiplexer according to the present invention includes a first star coupler and a second star coupler, both as described above. As input-output optical waveguides, the first star coupler has a single input optical waveguide and the second star coupler has two output optical waveguides. As channel optical waveguides, the first star coupler has a number of first channel optical waveguides and the second star coupler has a like number of second channel optical waveguides. The first and second channel optical waveguides are interconnected to form a waveguide array in which the optical length from the first star coupler to the second star coupler varies regularly across the array.

When a silicon core is employed in the above star coupler and optical multiplexer/demultiplexer, the high-index layer has the effect of reducing light loss.

### BRIEF DESCRIPTION OF THE DRAWINGS

In the attached drawings:

FIG. 1 is a schematic plan view of a star coupler in a first embodiment of the invention;

FIG. 2 is a sectional view through line B-B in FIG. 1;

FIG. 3A is a graph showing results of a simulation of the optical output intensity characteristics of the channel optical waveguides without the high-index layer in FIG. 1;

FIG. 3B is a graph showing results of a simulation of the optical output intensity characteristics of the channel optical waveguides with the high-index layer in FIG. 1;

FIG. 3C is a schematic plan view of the star coupler configuration in the simulations in FIGS. 3A and 3B;

FIG. 4 is a graph showing the total optical output power of the star coupler as a function of the refractive index of the high-index layers;

FIGS. 5A and 5B are sectional views illustrating variations of the star coupler structure in FIG. 2; and

FIG. 6 is a schematic perspective view of an optical multiplexer/demultiplexer in a second embodiment of the invention.

### DETAILED DESCRIPTION OF THE INVENTION

Preferred embodiments of the invention will now be described with reference to the attached drawings, in which like elements are indicated by like reference characters. Sizes, shapes, and positional relations are shown schematically and are only intended to provide an understanding of the invention. The numerical values and materials mentioned in the following descriptions are intended only as examples. Accordingly, the invention is in no way limited to the following embodiments.

### First Embodiment

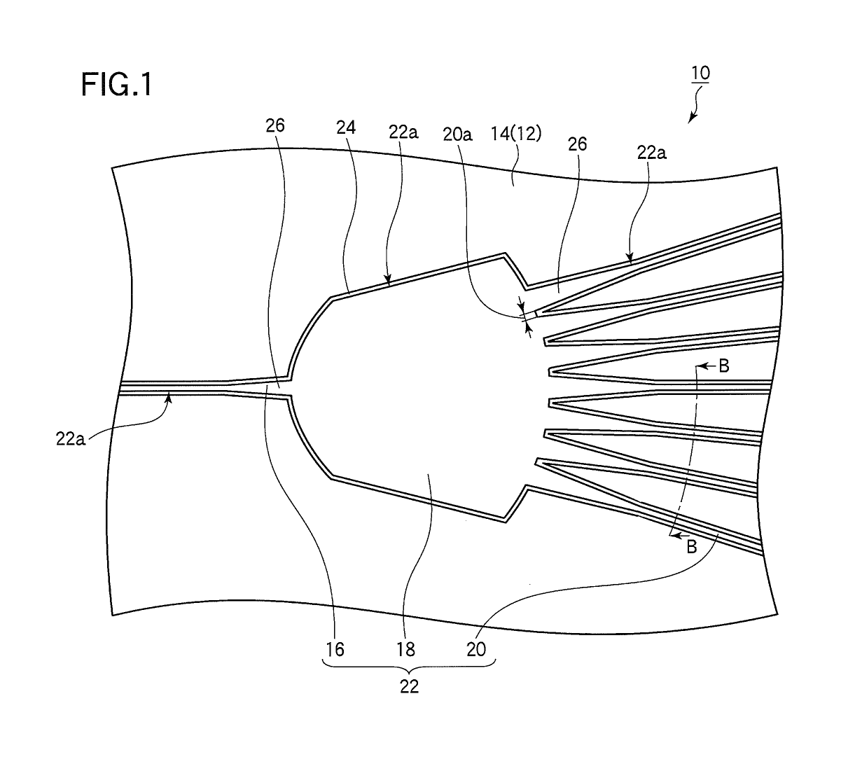

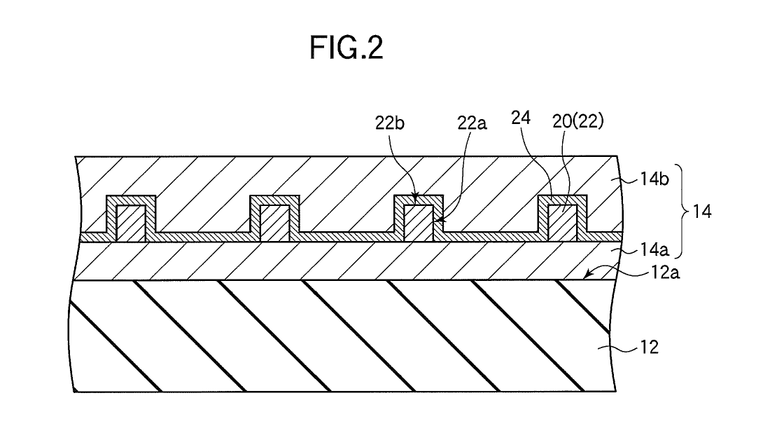

The structure of the star coupler in the first embodiment is shown in FIGS. 1 and 2. For clarity, the core in FIG. 1 is indicated by solid lines, even though it is embedded in the clad and would not be visible to the eye.

The star coupler 10 in FIGS. 1 and 2 includes a substrate 12, a clad 14 disposed on a major surface 12a of the substrate 12, and, embedded in the clad 14, an input-output optical waveguide 16, a slab optical waveguide 18, and a plurality of channel optical waveguides 20.

The input-output optical waveguide 16, slab optical waveguide 18, and channel optical waveguides 20 function as core elements in the clad 14, and will be referred to collectively below as the core 22. The sides of the core 22, more specifically the sides 22a orthogonal to the major surface 12a of the substrate, are entirely covered by a high-index layer 24. The high-index layer 24 also covers the top surface 22b of the core 22. ‘High-index’ in this specification means a refractive index higher than that of the clad 14. In this embodiment, the refractive index nf of the high-index layer 24 is preferably intermediate between the refractive index nc of the clad 14 and the refractive index nw of the core 22. In this embodiment, the clad 14 is preferably formed from silicon dioxide (SiO₂), which has a refractive index nc of 1.45. The core 22 is preferably formed from silicon, which has a refractive index nw of 3.5, differing by more than 40% from the refractive index of the clad 14. The high-index layer 24 is preferably formed from silicon nitride (SiN), which has a refractive index nf of 2.0

Next, the components of the star coupler 10 will be described in further detail with reference to FIG. 1.

The slab optical waveguide 18 has, for example, the general shape of an isosceles trapezoid, except that the top and bottom bases of the trapezoid are convex, each having a certain radius of curvature. The input-output optical waveguide 16 is connected to the center of the top base, which is shorter than the bottom base of the trapezoid. A plurality of channel optical waveguides 20 are connected at equal angular intervals to the bottom base, which is longer than the top base of the trapezoid. This embodiment has seven channel optical waveguides 20.

Equal angular intervals refers to equality of the angles between a plurality of lines radiating outward from the center of curvature of the bottom base. Therefore, the channel optical waveguides are disposed at equal angular intervals along the curve formed by the bottom base.

Light propagates from the slab optical waveguide 18 into the input-output optical waveguide 16 connected to the top base of the slab optical waveguide 18 as described above, or from the input-output optical waveguide 16 into the slab optical waveguide 18. The cross sectional dimensions of the input-output optical waveguide 16 in this embodiment are, for example, about 300 nm in the width direction parallel to the major surface 12a of the substrate 12 and 300 nm in the direction orthogonal to the major surface 12a. The connection between the input-output optical waveguide 16 and the slab optical waveguide 18 is formed by a tapered waveguide section 26 that increases in width as it approaches the slab optical waveguide 18. The length of the tapered waveguide section 26 in the direction of light propagation is about 10 μm, and the taper angle is about 10°. Provision of the tapered waveguide section 26 reduces light loss.

Light that propagates through the slab optical waveguide 18 splits off into each of the plurality of channel optical waveguides 20 connected at equal angular intervals to the bottom base of the slab optical waveguide 18. Similarly, light arriving through the plurality of channel optical waveguides 20 is combined in the slab optical waveguide 18. The cross sectional dimensions of the channel optical waveguides 20 are the same as the dimensions of the input-output optical waveguide 16. The connection between the slab optical waveguide 18 and each channel optical waveguide 20 is formed by a tapered waveguide section 26 that increases in width as it approaches the slab optical waveguide 18. The dimensions of these tapered waveguide sections 26 are the same as the dimensions of the tapered waveguide section 26 between the input-output optical waveguide 16 and the slab optical waveguide 18.

The space 20a between mutually adjacent channel optical waveguides 20 at the interface with the slab optical waveguide 18 is preferably, for example, about 300 nm. This value can be accurately controlled when the spaces 20a between the channel optical waveguides 20 are formed by dry etching. The space 20a is the distance between mutually facing sides of mutually adjacent tapered waveguide sections 26.

The high-index layer 24 covers the sides 22a of the core 22. The refractive index nf of the high-index layer 24 preferably satisfies the following condition (1), for a reason that will be described in more detail below.

0.12×(nw−nc)>nf−nc (1)

The thickness of the high-index layer 24 is preferably large enough that the spaces 20a between adjacent channel optical waveguides 20 are completely covered by the high-index layer 24. In this embodiment, since the spaces 20a are about 300 nm wide, the thickness of the high-index layer 24 is preferably 150 nm or greater, equal to half or more of the space width. The spaces 20a are therefore completely filled by the high-index layer 24, so part of light that would otherwise be lost by radiation through the spaces 20a to the outside is captured by the high-index layer 24 and returned to the channel optical waveguide 20.

Next, the cross sectional structure of the channel optical waveguides 20 of the star coupler 10 will be described with reference to FIG. 2.

The channel optical waveguides 20 shown in FIG. 2 and the rest of the core 22 are embedded in the clad 14 formed on the major surface 12a of the substrate 12. The sides 22a orthogonal to the major surface 12a and the top surface 22b of each channel optical waveguide 20 are entirely covered by the high-index layer 24.

The clad 14 comprises a lower clad 14a formed on the major surface 12a of the substrate 12 and an upper clad 14b formed on the lower clad 14a. The channel optical waveguides 20 are seated on the lower clad 14a. The high-index layer 24 is formed on the entire top surface of the lower clad 14a, also covering the top surfaces and sides of the channel optical waveguides 20.

A known silicon on insulator (SOI) substrate can be used in the structure of the star coupler 10. The SOI substrate includes the substrate 12, the lower clad 14a, and a topmost silicon layer. The channel optical waveguides 20 are formed by patterning of the topmost silicon layer in the planar pattern shown in FIG. 1 by a method well known in the art, such as dry-etching. The high-index layer 24 is then deposited on the entire top surface of the lower clad 14a and the exposed surfaces of the core 22 by a well known process such as chemical vapor deposition (CVD). Finally, the upper clad 14b is formed, by CVD, for example, covering the entire top surface of the high-index layer 24.

The operation of the star coupler 10 will now be described with reference to FIG. 1. In the following description, the input-output optical waveguide 16 is used as an input waveguide, and light entering the slab optical waveguide 18 therefrom propagates into the plurality of channel optical waveguides 20. However, the star coupler 10 may also operate with light propagating in the reverse direction, from the channel optical waveguides 20 through the slab optical waveguide 18 to the input-output optical waveguide 16, and the following discussion applies in reverse to this case.

When light that has propagated through the input-output optical waveguide 16 reaches the slab optical waveguide 18, it is spread by diffraction in the slab optical waveguide 18. The spread light is collected by the tapered waveguide sections 26 of the channel optical waveguides 20 and coupled into each of the channel optical waveguides 20.

Some of the light spread by diffraction in the slab optical waveguide 18 arrives at the spaces 20a between adjacent channel optical waveguides 20. In the prior art, which lacks the high-index layer 24 in the spaces 20a, the light arriving at a space 20a radiates through the space 20a to the outside, resulting in marked light loss. In the star coupler 10 in this embodiment, the high-index layer 24 on the sides 22a of the core 22, particularly in the spaces 20a, confines part of the light arriving at the spaces 20a so that it does not escape to the outside. The light confined in the high-index layer 24 is coupled into the channel optical waveguides 20, which have a higher refractive index. As a result, the star coupler 10 in this embodiment has less light loss than a conventional star coupler.

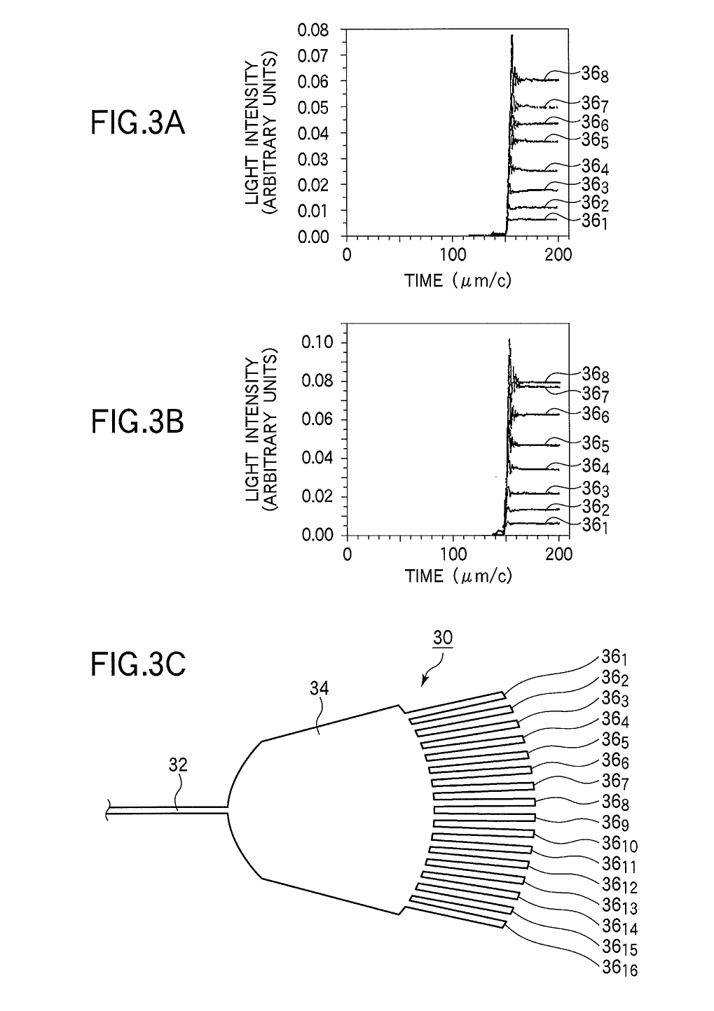

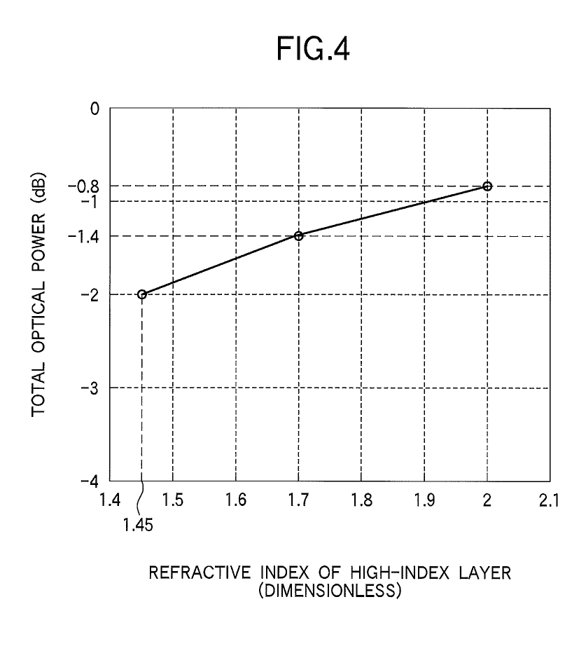

The effect of the star coupler 10 will now be described with reference to FIGS. 3A to 3C and FIG. 4.

FIGS. 3A and 3B are graphs showing results of a simulation of the output intensity characteristics of the channel optical waveguides of the star coupler. Light intensity is indicated in arbitrary units on the vertical axis and time is indicated in units of μm/c, where c denotes the velocity of light, on the horizontal axis. The interval between scale marks on the vertical axis differs between FIGS. 3A and 3B. FIG. 3C is a schematic plan view of the star coupler configuration used in the simulations in FIGS. 3A and 3B.

As shown in FIG. 3C, the star coupler 30 used for simulation is a 1×16 coupler having one input-output optical waveguide 32 on the top base of the slab optical waveguide 34 and sixteen channel optical waveguides 36₁ to 36₁₆ on the bottom base of the slab optical waveguide 34. The high-index layer 24 has a refractive index of 2.0 and a thickness of 200 nm.

The simulation was carried out by the three-dimensional finite difference time domain (FDTD) method. Light with a wavelength of 1500 nm was input into the input-output optical waveguide 32 in a step-functional manner, and the intensity of the light output from the channel optical waveguides 36₁ to 36₈ was calculated. Because of the line symmetrical arrangement of the channel optical waveguides in the star coupler 30, the intensities of the light output from channel optical waveguides 36₁ to 36₁₆ have line symmetrical values. FIGS. 3A and 3B therefore only show the intensity of the light output from half of the waveguides, specifically, the eight channel optical waveguides 36₁ to 36₈. The optical excitation efficiency to the input-output optical waveguides 16 was −1 dB.

FIG. 3A shows the optical output intensity characteristics of a conventional coupler in which the star coupler 30 is directly embedded in the clad 14 without a high-index layer 24 formed on its side surfaces. FIG. 3B shows the characteristics of the coupler in this embodiment, in which the high-index layer 24 is formed on the side surfaces of the star coupler 30.

A comparison of FIGS. 3A and 3B shows distinct differences between them in the output light intensity from the channel waveguides 36₁ to 36₈. The intensity is significantly greater in the coupler of the present embodiment (FIG. 3B) than in the conventional coupler (FIG. 3A). Table 1 summarizes this tendency.

TABLE 1

| | |
|---|---|
| Channel | |
| optical | Light intensity (arbitrary units) |

| waveguide | Conventional (FIG. 3A) | Embodiment (FIG. 3B) |
|---|---|---|
| 36₁ | 0.007 | 0.007 |
| 36₂ | 0.012 | 0.013 |
| 36₃ | 0.02 | 0.022 |
| 36₄ | 0.026 | 0.034 |
| 36₅ | 0.038 | 0.046 |
| 36₆ | 0.045 | 0.063 |
| 36₇ | 0.05 | 0.075 |
| 36₈ | 0.06 | 0.079 |

Table 1 clearly shows that the star coupler 30 in this embodiment, equipped with a high-index layer 24, has less light loss than the conventional star coupler.

Next the effects of the star coupler of the present invention will be described with reference to FIG. 4.

FIG. 4 is a graph showing the output characteristics of the star coupler. The total optical power of the light propagating through the channel optical waveguides 20 is indicated in decibels (dB) on the vertical axis, with 0 dB representing the case of no light loss. The (dimensionless) refractive index of the high-index layer 24 is indicated on the horizontal axis. The point where the refractive index is 1.45 represents a conventional coupler in which the high-index layer 24 and the clad 14 are both formed of SiO₂ and have the same refractive index, or equivalently, the star coupler 30 is directly embedded in the clad 14 without using a high-index layer 24. The point where the refractive index is 2.00 represents the star coupler 10 in this embodiment.

A comparison of the conventional coupler (refractive index: 1.45) with the star coupler in this embodiment (refractive index: 2.00) shows a 1.2-dB improvement in total optical power in the star coupler in the present embodiment as compared to the conventional star coupler. At the point where the high-index layer 24 has a refractive index of 1.7, the improvement in total optical power is less than 1 dB, which is inadequate. Based on these data, the refractive index of the high-index layer 24 is preferably larger than the sum of the refractive index of the clad 14 and 12% of the difference in refractive index between the core 22 and the clad 14. This is the relation expressed by the equation (1) given above.

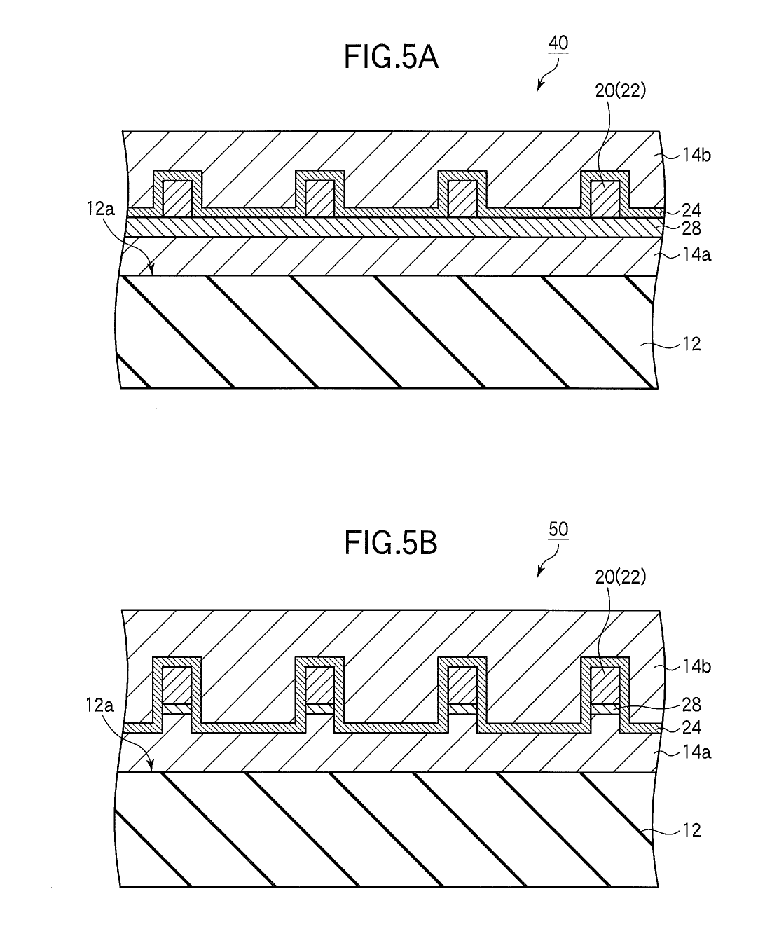

Variations of the first embodiment are illustrated in FIGS. 5A and 5B. FIGS. 5A and 5B are sectional views similar to FIG. 2.

The star coupler 40 in FIG. 5A differs from the star coupler 10 in FIG. 2 in that a lower high-index layer 28 having a refractive index equal to that of the high-index layer 24 is formed on the entire top surface of the lower clad 14a. The core 22 and the high-index layer 24 are formed on the lower high-index layer 28.

In this configuration, the refractive index distribution becomes symmetrical in directions orthogonal to the major surface 12a of the substrate. As a result, the light field distribution in the channel optical waveguides 20 also becomes symmetrical, slightly reducing the light loss.

The star coupler 50 in FIG. 5B is an improvement on the star coupler 40 in FIG. 5A. In star coupler 40, the bottoms of the channel optical waveguides 20 are in contact with a stack of layers consisting of the lower high-index layer 28 and the high-index layer 24, and the possibility exists that light propagating through the channel optical waveguides 20 may escape through the stack of layers to the outside.

In the star coupler 50 in FIG. 5B, this stacking of the lower high-index layer 28 and the high-index layer 24 is interrupted to prevent light loss via this route. After the channel optical waveguides 20 are formed on the lower high-index layer 28, the lower high-index layer 28 and lower clad 14a are selectively dry-etched to eliminate unnecessary parts of the lower high-index layer 28. The high-index layer 24 is then formed on the lower clad 14a and core 22 by CVD, for example. The remaining parts of the lower high-index layer 28 cannot carry light away from the channel optical waveguides 20.

### Second Embodiment

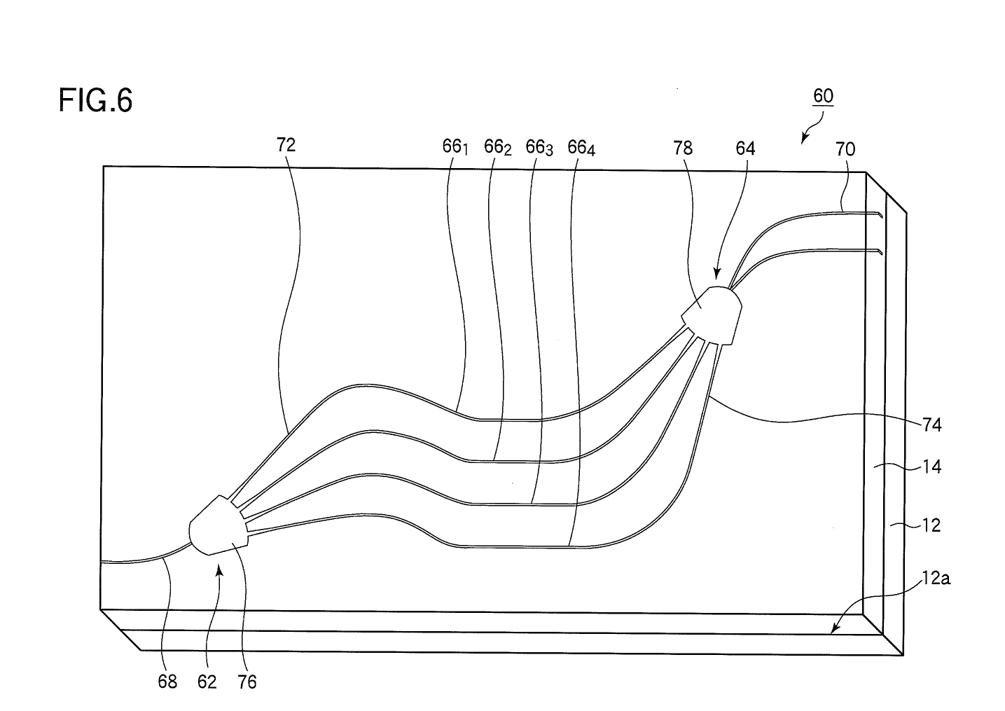

The second embodiment is an AWG optical multiplexer/demultiplexer with the structure shown in schematic perspective view in FIG. 6. For clarity, the optical multiplexer/demultiplexer 60 is indicated by solid lines, even though it is embedded in the clad 14 and would not be visible to the eye.

The clad 14 in which the optical multiplexer/demultiplexer 60 is embedded is formed on the major surface 12a of a substrate 12. The optical multiplexer/demultiplexer 60 comprises a first star coupler 62 and a second star coupler 64, each similar to the star coupler 10 described in the first embodiment. The optical multiplexer/demultiplexer 60 further comprises arrayed waveguides 66₁ to 66₄ that interconnect the first star coupler 62 and the second star coupler 64.

The first star coupler 62 has a single input optical waveguide 68 identical to the input-output optical waveguide in the first embodiment, a slab optical waveguide 76 identical to the slab optical waveguide in the first embodiment, and channel optical waveguides 72 similar to the channel optical waveguides in the first embodiment.

The second star coupler 64 has two output optical waveguides 70, each similar to the input-output optical waveguide in the first embodiment, a slab optical waveguide 78 identical to the slab optical waveguide in the first embodiment, and channel optical waveguides 74 similar to the channel waveguides in the first embodiment.

The arrayed waveguides 66₁ to 66₄ constitute a waveguide array by which the channel optical waveguides 72 and channel optical waveguides 74 are mutually interconnected. The lengths of these waveguides 66₁ to 66₄ vary regularly. When the optical multiplexer/demultiplexer in this embodiment is used as an optical network unit (ONU) in an optical subscriber telecommunication system, the difference in optical length between the arrayed waveguides 66₁ to 66₄ is 0.66 μm in order to multiplex and demultiplex light having wavelengths of 1.31 μm and 1.49 μm.

The operation of the optical multiplexer/demultiplexer 60 will be briefly explained with reference to FIG. 6. A mixture of light having a wavelength of 1.31 μm and light having a wavelength of 1.49 μm is input from the input optical waveguide 68 through slab optical waveguide 76 to the arrayed waveguides 66₁ to 66₄. As the mixed light propagates through the arrayed waveguides 66₁ to 66₄, the phase difference necessary to separate its two wavelength components is introduced. Light of one wavelength exits slab optical waveguide 78 into one of the two output optical waveguides 70; light of the other wavelength exits slab optical waveguide 78 into the other one of the two output optical waveguides 70.

Since the optical multiplexer/demultiplexer 60 uses star couplers similar to the star coupler 10 in the first embodiment, light loss during propagation is suppressed more effectively than when conventional couplers are used, as described above. Furthermore, because the second embodiment uses two star couplers, the effect of the reduced light loss is doubled, compared to a device with one star coupler.

In addition to the variations shown in the drawings, those skilled in the art will recognize that further variations of the preceding embodiments are possible within the scope of the invention, which is defined in the appended claims.

What is claimed is:

1. A star coupler comprising:
a substrate having a major surface;
a clad disposed on the major surface of the substrate, the clad having a first refractive index;
a core embedded in the clad, the core including a slab optical waveguide, at least one input-output optical waveguide connected to the slab optical waveguide, and a plurality of channel optical waveguides connected to and radiating out from the slab optical waveguide, the core having sides orthogonal to the major surface of the substrate, the core having a second refractive index that differs from the first refractive index by at least 40%; and
a high-index layer covering the sides of the core orthogonal to the major surface of the substrate, the high-index layer having a third refractive index intermediate between the first refractive index and the second refractive index.

2. The star coupler of claim 1, wherein the core is formed of silicon.

3. The star coupler of claim 1, wherein the clad is formed of silicon dioxide.

4. The star coupler of claim 1, wherein the high-index layer is formed of silicon nitride.

5. The star coupler of claim 1, wherein the core has an upper surface parallel to the major surface of the substrate, and the high-index layer also covers the upper surface of the core.

6. The star coupler of claim 5, wherein the core has a bottom surface parallel to the major surface of the substrate, and the high-index layer also covers the bottom surface of the core.

7. The star coupler of claim 6, wherein the high-index layer on the sides of the core extends below the bottom surface of the core.

8. The star coupler of claim 1, wherein the refractive index nw of the core, the refractive index nc of the clad, and the refractive index nf of the high-index layer satisfy the condition
0.12×(nw−nc)>nf−nc.

9. The star coupler of claim 1, wherein the high-index layer has a thickness greater than one-half the width of the spaces between mutually adjacent channel optical waveguides at the interface between the channel optical waveguides and the slab optical waveguide.

10. An optical multiplexer/demultiplexer comprising a first star coupler and a second star coupler both as defined in claim 1; wherein
the first star coupler has a single input optical waveguide as its at least one input-output optical waveguide;
the second star coupler has two output optical waveguides as its at least one input-output optical waveguide; and
the first and second star couplers have identical numbers of channel optical waveguides, the channel optical waveguides of the first star coupler being interconnected with respective channel optical waveguides of the second star coupler to form an array of waveguides with regularly varying optical lengths extending from the first star coupler to the second star coupler.
